(19) United States
(12) Patent Application Publication
(10) Pub. No.: US 2013/0266021 A1
(43) Pub. Date: Oct. 10, 2013

(54) BUFFER MANAGEMENT SCHEME FOR A NETWORK PROCESSOR

(71) Applicants: Claude Basso, Raleigh, NC (US); Jean L. Calvignac, Raleigh, NC (US); Chih-jen Chang, Apex, NC (US); Damon Philippe, Chapel Hill, NC (US); Michel L. Poret, Valbonne (FR); Natarajan Vaidhyanathan, Carrboro, NC (US); Fabrice J. Verplanken, LaGaude (FR); Colin B. Verrilli, Apex, NC (US)

(72) Inventors: Claude Basso, Raleigh, NC (US); Jean L. Calvignac, Raleigh, NC (US); Chih-jen Chang, Apex, NC (US); Damon Philippe, Chapel Hill, NC (US); Michel L. Poret, Valbonne (FR); Natarajan Vaidhyanathan, Carrboro, NC (US); Fabrice J. Verplanken, LaGaude (FR); Colin B. Verrilli, Apex, NC (US)

(21) Appl. No.: 13/990,587

(22) PCT Filed: Dec. 19, 2011
(86) PCT No.: PCT/EP2011/073256

§ 371 Date: May 30, 2013

(30) Foreign Application Priority Data
Dec. 21, 2010 (EP) 10306465.5

(51) Int. Cl. H04L 12/70

(52) U.S. Cl. CPC H04L 49/90
USPC 370/413

(57) ABSTRACT

The invention provides a method for adding specific hardware on both receive and transmit sides that will hide to the software most of the effort related to buffer and pointers management. At initialization, a set of pointers and buffers is provided by software, in quantity large enough to support expected traffic. A Send Queue Replenisher (SQR) and Receive Queue Replenisher (RQR) hide RQ and SQ management to software. RQR and SQR fully monitor pointers queues and perform recirculation of pointers from transmit side to receive side.

### CROSS-REFERENCE

The present application is a U.S. National Phase application which claims priority from International Application No. PCT/EP2011/073256, filed Dec. 19, 2011, which in turn claims priority from European Patent Application No. 10306465.5, filed Dec. 21, 2010, with the European Patent Office, the contents of both are herein incorporated by reference in their entirety.

### TECHNICAL FIELD

The present invention relates to a hardware system for managing buffers for queues of pointers to stored network packets.

### BACKGROUND

In traditional Network Interfaces Cards/Components, ingress and egress traffic is handled using dedicated queues of pointers. These pointers are memory addresses of where packets are stored when received from network and before transmission to network.

Software must permanently monitor that enough pointers (and related memory positions) are available for received packets, and also that pointers that have no more usage after packet has been transmitted are reused on the receive side. This task consumes resource and must be error free otherwise memory leakage will appear leading to a system degradation. Such a mechanism is used in current devices.

Patent U.S. Pat. No. 6,904,040 titled “Packet Preprocessing Interface for Multiprocessor Network Handler” assigned to International Business Machines Corporation granted on 2005, Jun. 7 discloses a network handler using a DMA device to assign packets to network processors in accordance with a mapping function which classifies packets based on its content.

### SUMMARY OF THE INVENTION

According to an aspect of the present invention, there is provided a network processor according to claim 1.

An advantage of this aspect is that the RQR and SQR hides most of the queue and buffer or cache management to the software. After initialization, software does not care anymore on buffer pointers.

Another advantage is that when software runs over multiple cores and/or in multiple threads, multiple applications may run in parallel without taking care about packet memory seen as a common resource.

Further advantages of the present invention will become clear to the skilled person upon examination of the drawings and detailed description. It is intended that any additional advantages be incorporated therein.

### BRIEF DESCRIPTION OF THE DRAWINGS

Embodiments of the present invention will now be described by way of example with reference to the accompanying drawings in which like references denote similar elements, and in which:

FIG. 1 shows a high level view of a system for managing packets in one embodiment of the present invention.

FIG. 2 shows a send queue replenisher (SQR) in an embodiment of the present invention.

FIG. 3 shows a possible format for a send queue work element (SQWE) stored in a send queue managed by an SQR, in an embodiment of the present invention.

FIG. 4 shows a receive queue replenisher (RQR) in an embodiment of the present invention.

FIG. 5 shows a possible format for a receive queue work element (RQWE) stored in a receive queue managed by an RQR, in an embodiment of the present invention.

FIG. 6 shows an enqueue pool and a dequeue pool for enqueueing and dequeueing SQWE to a send queue, in an embodiment of the present invention.

FIG. 7 shows an enqueue pool and a dequeue pool for enqueueing and dequeueing RQWE to a receive queue, in an embodiment of the present invention.

### DETAILED DESCRIPTION OF EMBODIMENTS

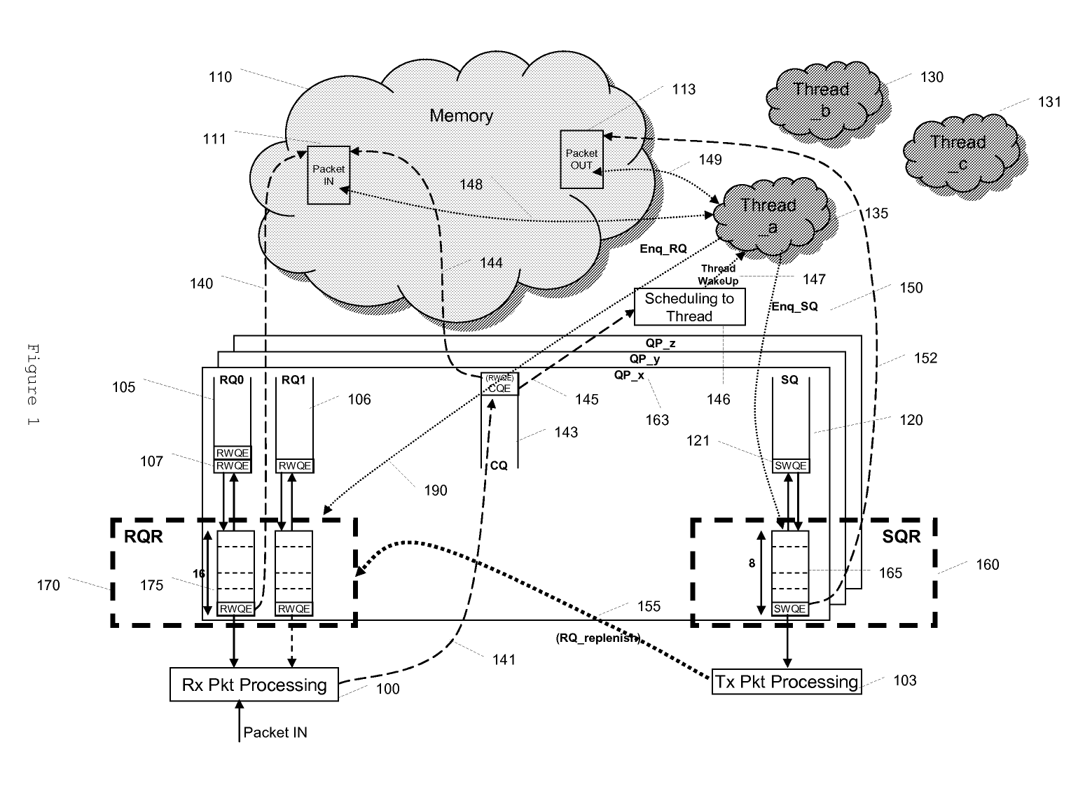

FIG. 1 shows a high level view of a system for managing packets, wherein:
a packet is received at a network interface corresponding to one of the queue pairs (163) of the network processor and is dispatched for processing (100);
a receive queue work element (RQWE) (107) is dequeued from a first receive queue (RQ0) (105);
a RQWE points (140) towards an address in memory (110) corresponding to a memory location (111) where the incoming packet can be stored; in a preferred embodiment a second receive queue (RQ1) (106) is provided comprising pointers to memory locations for storing large packets (for example larger than 512 bytes) whilst the first receive queue comprises pointers to memory locations for storing small packets (for example smaller than 512 bytes), the choice of the receive queue from which to dequeue an RQWE thus depending on the size of the incoming packet;
software threads (130, 131, 135) can be activated to process an incoming packet stored in memory: upon storing of an incoming packet in a memory location (111) which is free and large enough for accommodating such incoming packet, a message is sent to an available thread (135) so as to notify it to process the packet;
thread notification can comprise the steps of enqueueing (141) a RQWE to a queue (CQ) (143) after it was removed from the receive queue (105) so that it is not used to store another incoming packet—at least not until the processing of the packet is complete and the processed packet is transmitted, then a completion unit, a hardware component not represented in FIG. 1, can process (145) an element in the CQ and schedule (146) this element to an available thread (135), for instance by sending a thread wakeup interrupt (147). In a preferred embodiment the element sent to an available thread comprises a pointer (144) to the packet to be processed (111), and if there are several receive queues, an identifier of the receive queue of origin (105) for this pointer and of the queue pair (163) to which this receive queue belongs. Thanks to these parameters, it will be possible to recycle the pointer to its receive queue of origin, thereby achieving automatic memory management of pointers.
the software thread (135) starts processing (148) the incoming packet and stores (149) the processed packet at a second memory location (113). In most of the cases, the second memory location (113) will be the same as the first memory location (111).
the software thread (135) then sends, in a fire and forget manner, an enqueue request (150) of a send element to the completion unit, for it to transfer that request to the appropriate transmit interface. In a preferred embodiment, the send element provided by the software thread (135) comprises a pointer to the processed packet (113), an identifier of the receive queue of origin for that pointer and of the queue pair to which it belongs. At this point, the handling of the enqueue action up to the recycling of the memory pointer is transparent for the software.
the completion unit will then send a SQWE to the SQR (160) for enqueueing it in the relevant SQ (120). In a preferred embodiment of the present invention, a hardware buffer (165) is used to enqueue a SQWE (121) in the send queue (120). A SQWE comprises a pointer (152) to a memory location (113). The completion unit is typically responsible for ensure dispatching in the appropriate order of the SQWE to the SQR.
upon transmit of the packet by the relevant transmit interface (103), a queue manager, a hardware component not represented in FIG. 1, sends (155) the SQWE to the RQR (170) so that it is recycled in its receive queue (105) of origin. The receive queue of origin and the queue pair will be identified by the identifier comprised in the SQWE. In a preferred embodiment of the present invention, the RQR (170) uses a hardware buffer (175) to enqueue the recycled pointer address to the receive queue (105).

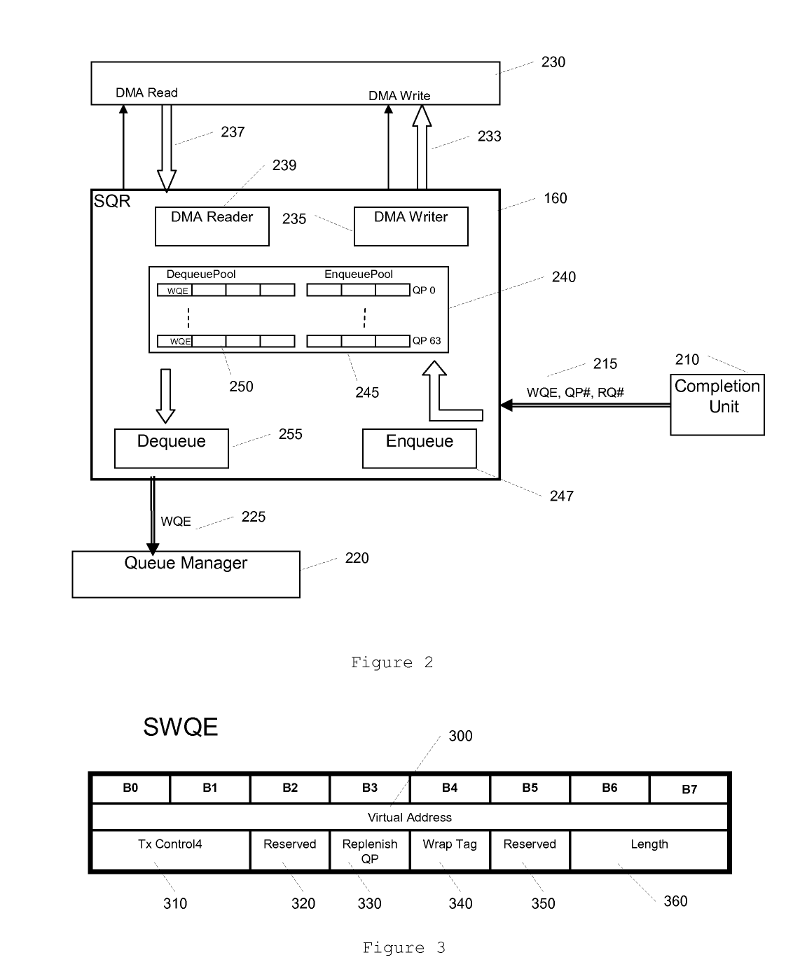

FIG. 2 shows a send queue replenisher (SQR) (160) in an embodiment of the present invention, comprising:
a DMA writer (235) and a DMA reader (239);
a set (240) of enqueue (245) and dequeue pools (250);
a module for handling enqueue requests (247);
a module for handling dequeue requests (255).

The SQR receives a send queue element (215) (or SQWE) from the completion unit (210). The role of the completion unit comprises:
receiving from a software thread (135) a send queue element comprising a pointer to a packet in memory and an identifier of the receive queue of origin of the pointer and of the queue pair to which this receive queue belongs (215);
sending to said SQR said send queue element.

The dequeue module (255) will send to the queue manager (220) the dequeued send work element (225) (represented as a WQE in FIG. 2) at the head of the dequeue pool (250), so that the queue manager transports this queue element to the RQR for recycling, preferably after the corresponding packet has been transmitted.

When an enqueue pool (245) is full, the SQR will write (233) its content to memory (230) using the DMA Writer (235) and empty the enqueue pool (245). Furthermore, when a dequeue pool is empty, the SQR will refill it by reading (237) one or more SQWE from memory (230) using the DMA Reader (239) and copying them to the dequeue pool (250).

One dequeue pool (250) and one enqueue pool (245) are in general associated with one send queue in memory. Furthermore there are in general one dequeue pool (250) and one enqueue pool (245) for each queue pair. Finally the enqueue pool (245), the dequeue pool (250) and the associated send queue are in general first in first out (FIFO) queues. A main reason for this configuration is to ensure that the SQWEs are transmitted in the order they are enqueued by the completion unit (210). It is possible to choose different configuration for the enqueue (245) and dequeue pool (250) and for the receive queue (either not FIFO, or in different numbers), however such configurations would require further mechanisms to ensure packets are transmitted in order. However such implementations would not deviate from the teachings of the present invention.

FIG. 3 shows a possible format for a send queue work element (SQWE) stored in a send queue managed by an SQR, comprising:
a virtual address (300) in memory of the packet to be transmitted;
a transmit control code (310) used for transmit of the packet;
a reserved field (320);
a replenish QP field (330) comprising in a preferred embodiment an identifier of the receive queue of origin to which the virtual address (300) should be recycled and of the queue pair to which this receive queue belongs; optionally the replenish QP field (330) can comprise a flag to indicate whether the virtual address (300) should be recycled, so as to keep flexibility in the system;
a wrap tag (340) used for transmitting the packet;
another reserved field (350);
a packet length field (260) used for transmitting the packet.

In a preferred embodiment the SQWE is 16 bytes, and the virtual address (300) is 8 bytes.

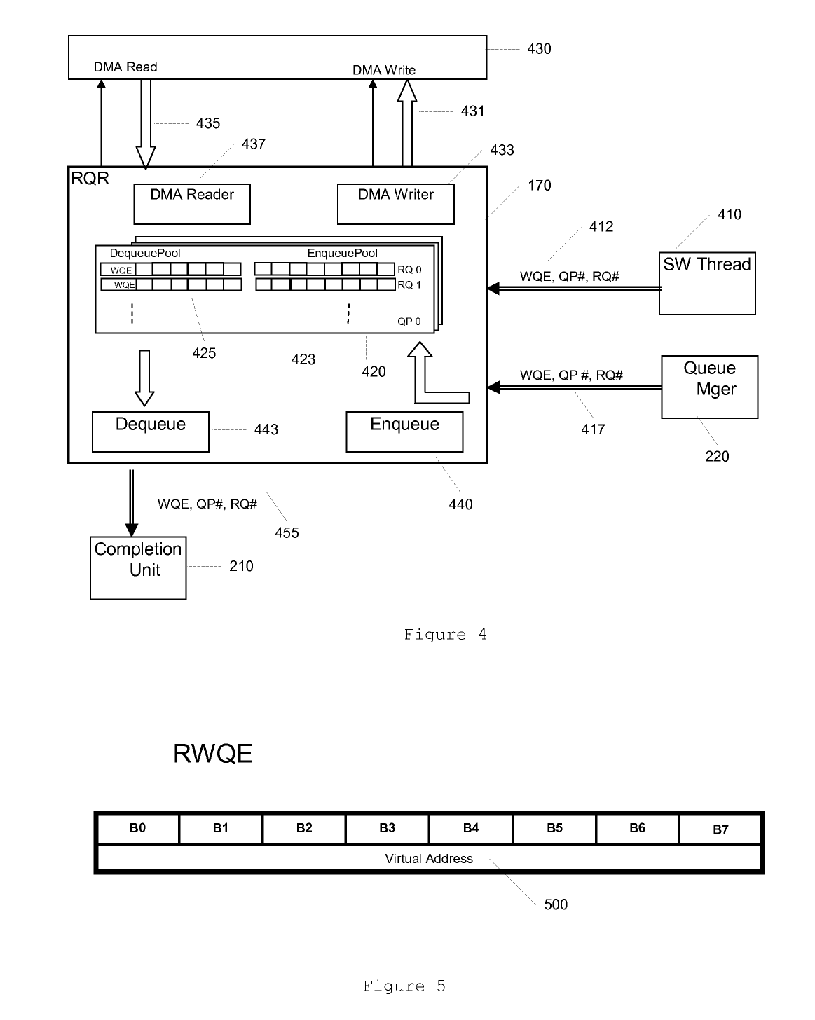

FIG. 4 shows a receive queue replenisher (RQR), comprising:
a DMA writer (433) for writing (431) to memory (430);
a DMA reader (437) for reading (435) from memory (430);
a set (420) of managed enqueue (423) and dequeue pools (425), each set (420) being associated with a queue pair, there is not limit to the number of enqueue (423) and dequeue pools (425) per set, although in a preferred embodiment there are two enqueue (423) and dequeue pools (425) per queue pair;
an enqueue module (440) for enqueueing an RQWE to an enqueue pool (423);
a dequeue module (443) for dequeueing an RQWE from a dequeue pool (425).

The RQR receives a RQWE for enqueueing along with an identifier of the queue pair and of the receive queue in which the RQWE should be enqueued. This element (412) is received at initialization time from a software thread (410). After initialization a RQWE, along with queue pair number and receive queue number (417), should in most of the cases be received from the queue manager (220), thus achieving automatic memory management by hardware. A case where a RQWE would be received from a software thread (410) after initialization is when the software decides to recycle the pointer itself.

Each enqueue (423) and dequeue pool (425) are associated with one receive queue stored in memory (430).

In case of a dequeue (443), a RQWE is removed from a dequeue pool (425) in the relevant queue pair (420) and is sent (455) to the completion unit (210) along with an identifier of the queue pair (420) and of the receive queue associated with the dequeue pool (425) from which the RQWE was pulled. The completion unit then forwards the element and the identifier to a software thread.

FIG. 5 shows a possible format for a receive queue work element (RQWE) stored in a receive queue managed by an RQR, comprising a virtual address (500). In a preferred embodiment, the size of a RQWE is thus the same as a virtual address (500), which is 8 bytes. However different sizes for the virtual address (500) can be contemplated. The size of the virtual address (300) in a SQWE should match the size of the virtual address (500) in an RQWE.

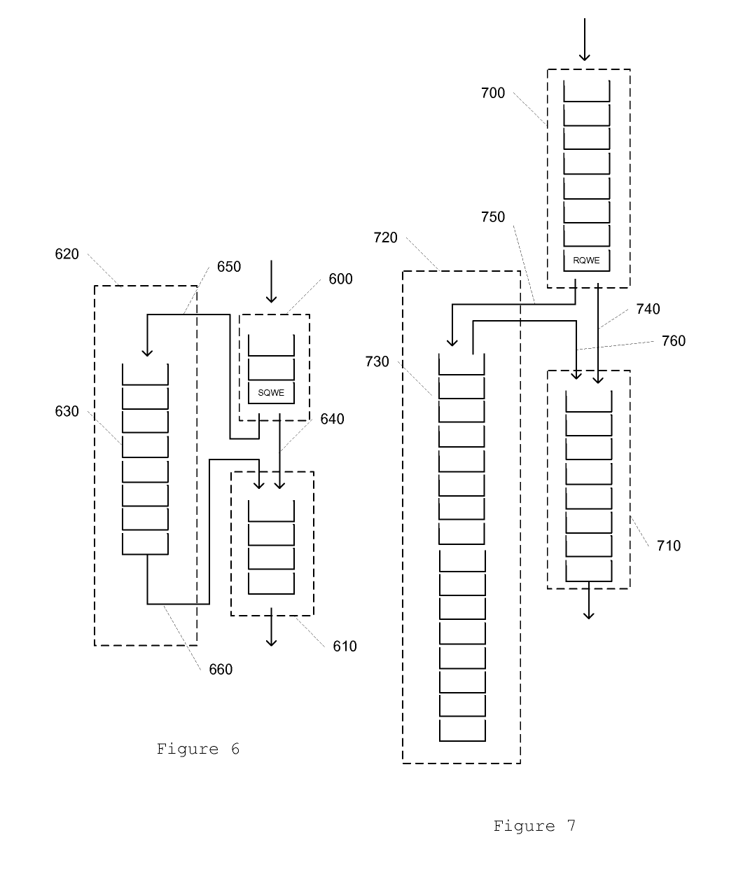

FIG. 6 shows an enqueue pool (600) and a dequeue pool (610) for enqueueing and dequeueing SQWE to a send queue (620) stored in memory.

The SQR maintains a hardware managed send queue (620) by enqueueing SQWE to the tail (650) of the send queue and dequeueing SQWE from the head (660) of the send queue. It receives SQWE from the Completion Unit (210) and provides SQWE to the queue manager (220). It maintains a small cache of RQWE per queue pair waiting to be DMAed to memory and another small cache of SQWE that were recently DMAed from memory. If the send queue is empty, there is a path (640) whereby writing and reading from memory can be bypassed, and SQWE are moved directly from the enqueue pool (600) to the dequeue pool (610).

In a preferred embodiment, the enqueue pool comprises a set of 3 latches for temporarily storing SQWE. When a 4th RQWE is received, the 3 SQWEs in the enqueue pool (600) and the received 4th SQWE are written to the tail of the send queue (620) stored in memory. The enqueue pool (600) could also comprise 4 latches.

In a preferred embodiment 4 SQWE of 16 bytes are written at the same time to memory using DMA write. This is optimal when a DMA allowing transfer of 64 bytes is used. Various numbers of SQWEs can be transferred simultaneously from and to memory based on the needs of a specific configuration.

In a preferred embodiment, the enqueue pool (600), the dequeue pool (610) and the send queue (620) are FIFO queues so that the order of SQWE as received from the completion unit (210) is maintained.

The number of elements (630) in the send queue (620) is determine at initialization time, however mechanisms can be put in place to dynamically extend the size of the send queue (620).

FIG. 7 shows an enqueue pool and a dequeue pool for enqueueing and dequeueing RQWE to a receive queue, comprising:
an enqueue pool (700);
a dequeue pool (710);
a receive queue (720) stored in memory.

RQR maintains a hardware managed receive queue (720) by enqueueing RQWE to the tail (750) of the queue and dequeueing RQWE from the head (760) of the queue. It receives RQWE from the queue manager (220) and from software (410) for example via ICSWX coprocessor commands. It then provides the RQWE to the identified receive queue and queue pair. It maintains a small cache (710) of RQWE per queue pair that were recently DMAed from memory or given by SQM/ICS. When the cache becomes near empty, RQR replenishes it by fetching (760) some RQWEs from the memory to serve the next request. In symmetric way, when the cache becomes near full, RQR writes (750) some RQWEs in the cache into the system memory to serve the next request from the queue manager or ICW. If the cache is neither near full nor near empty, RQWEs flow from providers to consumers (740) without going through system memory.

In a preferred embodiment, the enqueue pool (700) comprises a set of 8 latches for temporarily storing RQWEs. When a 8th RQWE is enqueued, the 8 RQWEs in the enqueue pool (700) are written to the tail of the receive queue (720) stored in memory. The enqueue pool (700) could also comprise different number of latches.

In a preferred embodiment 8 RQWE of 8 bytes are written at the same time to memory using DMA write. This is optimal when a DMA allowing transfer of 64 bytes is used. Various numbers of RQWEs can be transferred simultaneously from and to memory based on the needs of a specific configuration.

In a preferred embodiment, the enqueue pool (700), the dequeue pool (710) and the receive queue (720) can be FIFO queues, stacks or last in first out queues, as the order of RQWE does not need to be maintained.

The number of elements (730) in the receive queue (720) is determined at initialization time, however mechanisms can be put in place to dynamically extend the size of the receive queue (720).

Another embodiment comprises a method for adding specific hardware on both receive and transmit sides that will hide to the software most of the effort related to buffer and pointers management. At unitization, a set of pointers and buffers is provided by software, in quantity large enough to support expected traffic. A Send Queue Replenisher (SQR) and Receive Queue Replenisher (RQR) hide RQ and SQ management to software. RQR and SQR fully monitor pointers queues and perform recirculation of pointers from transmit side receive side.

RQ/RQR is preloaded with a number of RQWE large enough to guarantee no depletion of RQ until WQE may be received from SQ.

When a packet is received; using the hash performed on defined packet header fields, a QP is selected by the hardware; the RQWE at the head of the RQR cache for the corresponding RQ is used.

The RQWE contains the address where to store the packet content in memory; data transfer is fully handled by the hardware.

When the packet has been loaded in memory, a CQE is created by the hardware that contains: memory address used for storing packet (RQWE) miscellaneous data on packet (size, Ethernet flags, errors, sequencing . . . ).

The CQ is scheduled by the hardware to an available thread. The elected thread process the CQE.

The thread performs what is needed on the received packet to change it to a packet ready for transmission.

The thread enqueues the SQWE in SQ/SQR.

When at head of SQR cache, the packet is read by the hardware at address indicated in SQWE.

The packet is transmitted by the hardware using additional information contained in the SQWE.

If enabled in SQWE, the address of now free memory location is recirculated by the hardware in RQ as a RQWE.

Otherwise a CQE is generated by the hardware to indicate transmit completion to software; the WQE will have to be returned to RQ by software.

Another embodiment of the present invention handles all data movement tasks and all buffer management operations; threads have no more to care about these necessary but time costing tasks. Thus it highly increases performance by delegating to hardware all data movement tasks. Buffer management operations are further improved by using hardware cache that hide most latency due to DMA access while maximizing DMA efficiency (for example using a full cache line of 64B for transfer). Optionally the software can choose to fully use hardware capabilities or only use part of them.

1-10. (canceled)

11. A network processor for managing packets, the network processor comprising:
a receive queue replenisher (RQR) for maintaining a hardware managed receive queue the receive queue being suitable for handling a first pointer to a memory location for storing a packet which has been received;
a send queue replenisher (SQR) for maintaining a hardware managed send queue, the send queue being suitable for handling a first send element, the first send element comprising a second pointer to the memory location where the packet has been processed and is ready to be sent;
a queue manager for, in response to the packet having been sent, receiving the first send element from the send queue and sending the first send element to the RQR, for the RQR to add the second pointer to the receive queue so that the memory location can be reused for storing another packet.

12. The network processor of claim 11 wherein the first send element in the send queue further comprises an identifier of the receive queue, so as to indicate to the RQR to which receive queue the second pointer should be added.

13. The network processor of claim 11, wherein the receive queue and the send queue belong to different queue pairs, and wherein the receive queue identifier further comprises information for determining the queue pair to which the receive queue belongs.

14. The network processor of claims 11, wherein multiple software threads can run, the network processor further comprising a completion unit adapted for:
receiving the first pointer from the receive queue upon arrival of the incoming packet, so that the first pointer is removed from the receive queue;
providing to an available first software thread the received first pointer and an identifier of the receive queue, and scheduling the processing by the first software thread of the incoming packet;
once the incoming packet has been processed,
receiving from the software thread a send queue element comprising the second pointer and the identifier, wherein the second pointer points to the same memory location as the first pointer;
sending to the SQR the send queue element so as to enqueue it in the send queue.

15. The network processor of claim 11, wherein the send queue comprises:
a first FIFO queue stored in memory,
a first enqueue pool comprising a first set of latches,
a first dequeue pool comprising a second set of latches;
and wherein the SQR is adapted for:
using the first enqueue pool as a cache for enqueueing to the first FIFO queue several send elements simultaneously via direct memory access (DMA), and
using the first dequeue pool as a cache for dequeueing from the first FIFO queue several send elements simultaneously via DMA.

16. The network processor of claim 11, wherein any send element is 16 Bytes long, and 4 send elements can be enqueued to or dequeued from the first FIFO queue simultaneously.

17. The network processor of claim 11, wherein the receive queue comprises:
a second queue stored in memory,
a second enqueue pool comprising a third set of latches,
a second dequeue pool comprising a fourth set of latches;
and wherein the RQR is adapted for:
using the second enqueue pool as a cache for enqueueing to the second queue several pointers simultaneously via direct memory access (DMA), and
using the second dequeue pool as a cache for dequeueing from the second queue several pointers simultaneously via DMA.

18. The network processor of claim 17, wherein any pointer is 8 Bytes long, and 8 pointers can be enqueued to or dequeued from the second queue simultaneously.

19. The network processor of claim 17, wherein the second queue is a FIFO queue, a LIFO queue or a stack.

20. The network processor of claim 17, wherein the RQR can manage two receive queues per queue pair,
the first receive queue comprising pointers pointing to memory location for storing small packets (for example up to 512 bytes), and
the second receive queue comprising pointers pointing to memory location for storing large packets (for example larger than 512 bytes).
